(19) United States
(12) Patent Application Publication
(10) Pub. No.: US 2009/0223773 A1
(43) Pub. Date: Sep. 10, 2009

(54) Friction clutch for a torque transmission device

(75) Inventor: Andreas Ruehle, Stuttgart (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/380,734

(22) Filed: Mar. 3, 2009

(30) Foreign Application Priority Data
Mar. 6, 2008 (DE) 10 2008 012 860.0

(51) Int. Cl. F16D 13/60

(52) U.S. Cl. 192/107 R

(57) ABSTRACT

A friction clutch with at least a clutch cover, at least a pressure plate connected with it non-rotatably, though axially being limitedly displaceable, as well as an actuation means effective between said clutch cover and the pressure plate for axial force-exertion on the pressure plate.

### CROSS-REFERENCE TO RELATED APPLICATIONS

This application claims priority from German Patent Application No. 10 2008 012 860.0, filed on Mar. 6, 2008, which application is incorporated herein by reference in its entirety.

### FIELD OF THE INVENTION

The invention relates to a friction clutch or a torque transmission device equipped with it, wherein the friction clutch features at least a clutch cover and at least a pressure plate, connected non-rotatably in an axially displaceable manner, and the actuation means for exerting axial force on the pressure plate between the clutch cover and the pressure plate. The invention relates particularly to the so-called twin clutches.

### BACKGROUND OF THE INVENTION

Friction clutches of the type mentioned above—whether single-disc, twin-disc or multiple-disc clutches—retain some measure of imbalance after assembly; thus, the reason why the entire clutch assembly must be balanced in most cases. Already, trials have been made to minimize the residual imbalance, by initially balancing at least an individual component, but still, rebalancing has proved necessary in most cases. To eliminate such residual imbalances, it is common practice to later remove material from different components, for example, by introducing balancing holes or by removing material from the edge regions of component parts. It is also common practice to weld balancing weights or to use balancing rivets.

For very compact assemblies, however, it is often not possible to use the above-mentioned balancing methods, because, for instance, owing to very complex design of the components, it is not possible to weld properly without distorting the components. Moreover, in many cases, it is not possible to accommodate the dolly blocks for supporting the riveting forces required to fix balancing rivets.

### BRIEF SUMMARY OF THE INVENTION

The object of the present invention is to provide a simple and cost-effective balancing possibility for friction clutches, especially twin clutches. In particular, it should be ensured that optimal balancing of the clutch assembly is facilitated without material removal and without the effect of significant axial forces on the components of the friction clutch.

According to the invention, this object is achieved in that at least one constituent part must feature recesses in which screw elements used as balancing weights can be screwed to balance the friction clutch. Several groups of recesses distributed circumferentially can be provided advantageously on at least one component part of the friction clutch.

The screw elements used as a balancing weight can advantageously feature a threaded section that automatically forms the fixing thread.

Recesses for the screw elements can be provided advantageously on a clutch cover. For this purpose, the clutch cover can have several radially protruding regions on its outer circumference, in which corresponding recesses are formed.

Screw elements with different weights can find application advantageously. The screw elements, for instance, can be formed in a manner such that they have a threaded section and an adjoining screw head forming a balancing weight. The screw head can thereby advantageously feature a socket for a screw driving tool.

The friction clutch can advantageously form a so-called twin clutch comprising two single-disc clutches which can be actuated separately. The twin clutch can comprise a momentum disc or a flywheel with which a clutch cover is connected for drive purposes, wherein also a connection cover can be provided, which can be coupled with a pressure plate of one of the clutches. The two pressure plates of the twin clutch can be axially displaceable and loadable by means of actuation means that are effective between the clutch cover and the two pressure plates. One of the covers can feature at least recesses for receiving the balancing weights. The annular inertial mass designated here as flywheel is advantageously disposed axially between the pressure plates of the two clutches and can be coupled either indirectly or directly with the drive shaft of an engine. It can be suitable when the connection cover is connected with the pressure plate that faces the engine when operating the friction clutch.

For the design of the friction clutch it can be particularly advantageous when the clutch cover connected with the flywheel is at least partially accommodated inside the connection cover and has radially protruding sections, on its circumference, in which the recesses are provided for receiving the screw elements used as balancing weight.

The connection cover can feature several lobes, extending axially along its outer circumference, which form fastening sections for coupling with a pressure plate, whereby the radial sections of the coupling cover—when viewed in the circumferential direction of the friction clutch—are respectively provided between two such lobes.

It is particularly functional when the recesses for receiving the balancing weights relative to the rotation axis of the friction clutch are spaced such that they are at least axially accessible even in the assembled state of the twin clutch. Thus, particularly, when screw elements are used as balancing weight, they can be anchored in corresponding recesses by means of an axially applicable screw driving tool.

### BRIEF DESCRIPTION OF THE SEVERAL VIEWS OF THE DRAWING

Further advantages, features, and details of the invention can be derived from the following description of an exemplary embodiment.

The figures are as follows:

FIG. 1 shows a section of a torque transmission device that comprises a friction clutch executed according to the invention; and,

FIG. 2 shows a partial perspective view of the friction clutch according to FIG. 1.

### DETAILED DESCRIPTION OF THE INVENTION

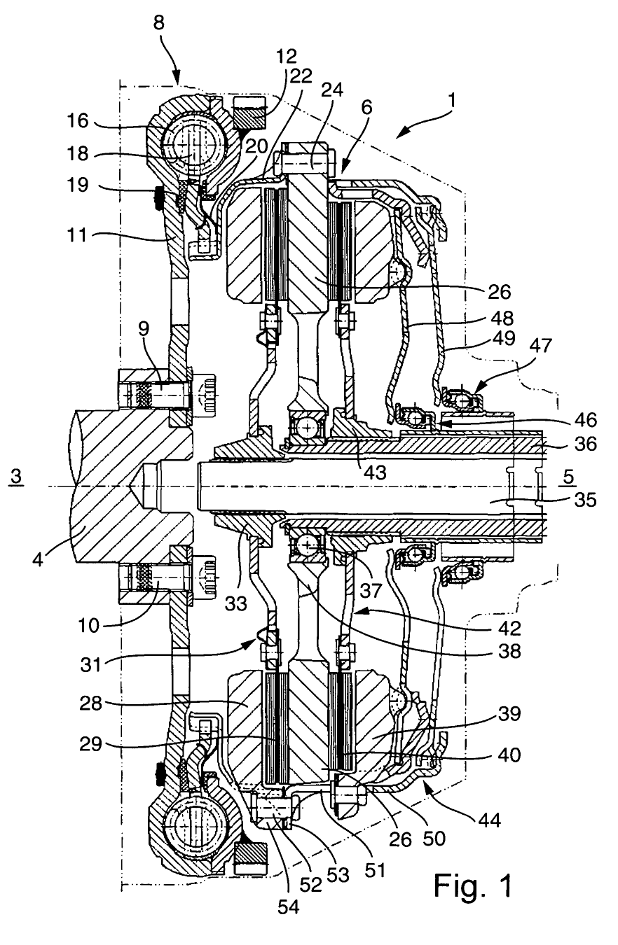

A part of a power train 1 of a motor vehicle is depicted in FIG. 1. A twin clutch 6 is disposed between a drive unit 3, particularly of an internal combustion engine, from which a crankshaft 4 originates, and a transmission 5. A torsional vibration damping device 8 is interposed between the drive unit 3 and the twin clutch 6. The torsional vibration damping device 8 is operational as a dual mass flywheel in this case.

The crankshaft 4 of the internal combustion engine 3 is connected non-rotatably by means of screws 9, 10 with an input part 11 of the torsional vibration damping device 8. The input part 11 of the torsional vibration damping device 8 essentially has the shape of a circular disc, extending in radial direction, which forms a vibration damper cage outwards. On the input part 11 a ring gear 12 is fixed radially outwards. In the vibration damper cage, at least one energy storage device, in particular a spring device 16, is accommodated at least partially. In the spring device 16, an output part 18 engages with the torsional vibration damping device 8. Between the input part 11 and the output part 18, a friction ring 19 is fixedly disposed on the input part 11.

Radially inside, the output part 18 of the torsional vibration damping device 8 is detachably engaged by means of an axially inserted connection 20, thus it is detachably, non-destructively, connected with the clutch-cover part 22. A flywheel formed as an intermediate pressure plate 26 is fastened with the help of rivet connections, to the clutch-cover part 22 in the section drawing, of which only one is visible. On the driven side, friction linings 29 of a first clutch disc 31 can be clamped between the intermediate pressure plate 26 and a pressure plate 28. The first clutch disc 31 is non-rotatably connected with a first transmission input shaft 35, via a hub part 33, which is formed as a solid shaft. The first transmission input shaft 35 is rotatably disposed inside a second transmission input shaft 36 which is formed as a hollow shaft. A hub part 38 is rotatably mounted, with the help of a roller bearing 37, on the driven-side end of the second transmission input shaft 36 that is part of the intermediate pressure plate 26. On the transmission side, friction linings 40 of a second clutch disc 42 can be clamped between the intermediate pressure plate 26 and a pressure plate 39. The second clutch disc 42 is connected non-rotatably via a hub part 43 with the second transmission input shaft 36.

The twin clutch 6 features a clutch cover 44 that is axially displaceable relative to the pressure plates 28, 39, though non-rotatably. The intermediate pressure plate 26 is non-rotatably connected with the clutch cover 44. The clutch cover 44 and the intermediate pressure plate 26 are connected with the crankshaft 4 via the clutch-cover part 22 and the torsional vibration damping device 8. The twin clutch 6 is actuated in a common manner via actuation devices 46, 47 which interact with actuation elements, such as the actuation levers 48, 49.

The pressure plate 28 is connected with the actuation levers 49 via a pot-shaped pulling element 50, which is connected non-rotatably with the pressure plate 28, via several axial lobes 51 distributed over the circumference. This connection is by means of rivet connections 52 in the depicted exemplary embodiment, which interact with radial lobes 53 aligned outwards on the axial lobes 51.

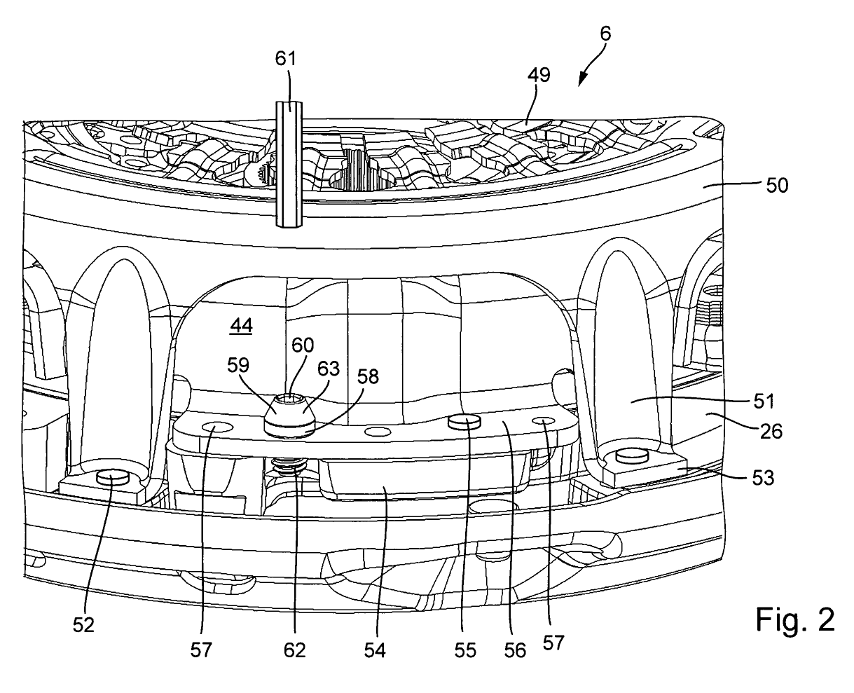

The actuation levers 48, 49 are supported on the clutch cover 44 in a swivel-capable manner. The actuation levers 48, 49 can be formed advantageously by a plurality of levers disposed in annular arrangement, wherein the levers can be formed with an annular region formed with them as a single piece. The levers can be component of a disc-spring-like component. As is apparent from FIG. 2, the intermediate pressure plate 26 has several radial lobes 54 distributed over the circumference, on which the clutch cover 44 is fixed. This fixture can likewise occur by means of a riveted connection 55. However, also other connections, for example, screw connections can find application.

From FIG. 2, it is apparent that the clutch-cover 44 features radially protruding regions 56 on its circumference, which are formed like a lobe. In the depicted exemplary embodiment, these radial regions 56 are for connecting the cover 44 with the radial lobes 54 of the intermediate pressure plate 26.

In the radial regions 56 a multiple of number of recesses 57, distributed in the circumferential direction is preferably provided, which are formed to receive the balancing elements 58. In the depicted exemplary embodiment, the balancing elements 58 are formed by screw elements 59. The balancing elements 58 have tool sockets 60 for a fixing tool 61. In the depicted exemplary embodiment, the balancing elements 58, formed by screw elements 59, can be inserted into the recesses 57 by means of the fixing tool 61 formed as an Allen key. The screw elements 59 preferably form the so-called thread-tapping or self-cutting screws, which facilitate the application of smooth recesses 57.

The screw elements 58 have a threaded section 62 and a screw head 63 formed as a balancing mass. Screw elements 58 with different masses or weights can find application in a preferable manner. Thus, the threaded section 62 can be uniform, the screw heads 63, however, can be formed in different sizes.

The pulling element 50 which is axially movable by means of actuation levers 49 and connected non-rotatably with the pressure plate 28 can be designated also as a connection cover 50. From FIG. 2, it is apparent that the radial regions 56 of the clutch cover 44—viewed in circumferential direction of the twin clutch 6—are provided respectively between the two axial lobes 51.

From FIG. 2 it is also apparent that the recess 57, in relation to the rotation axis of the twin clutch 6, is disposed in such a manner that the balancing elements 58 can be brought into the latter also with a mounted twin clutch 6. Thus, it can be particularly functional when the recesses 57 are disposed at least essentially radially outside the regions axially opposite them. In this manner, it is ensured that the screw elements 59 can be screwed in by means of the fixing tool 61 in the corresponding recesses 57. It is functional when the recesses 57 are placed in the radial regions 56 in a manner such that they are disposed offset radially outwards opposite a fictitious enveloping surface of the connection cover 50.

In the depicted exemplary embodiment, the radial regions, which serve for receiving the balancing elements 58 and for fastening with the intermediate pressure plate 26, are the same. Different radial regions 56 could be distributed over the circumference, however, upon demand, are formed only for receiving the balancing elements 58 or fastening elements 55. However, also regions can be provided, which can receive both the balancing elements 58 as well as the fastening elements 55.

The embodiment according to the invention is not limited to the described exemplary embodiment, but can very generally find application in twin clutches. Thus, for instance, the intermediate pressure plate 26 can be connected non-rotatably with a disc driven by an engine without interposition of a torsional vibration damping device 8. The manner of centering or supporting the clutch assembly or the twin clutch 6 can be different also from that depicted in FIG. 1. Thus, for instance, the twin clutch 6 can be kept centered directly via a disc driven by the engine, so that the bearing 37 can be omitted.

The twin clutch 6 could be centered also, at least partially, via the transmission cover or a component part connected with the latter. Centering or supporting the twin clutch 6 must thereby take place such that also an axial support of the actuation forces exerted on the actuation levers 48, 49 is guaranteed.

The embodiment according to the invention has the advantage that the balancing elements can be fixed practically without exertion of an axial force on the anchoring regions provided. Therefore, neither the supporting elements nor dolly blocks are required, for example, in order to mount balancing elements 58 formed as screw elements. As balancing elements 58, also the so-called blind rivets could find application advantageously, and they practically do not require any axial force to anchor them in a recess. The balancing elements 58 could be formed advantageously also by self-locking elements that are slidable onto the fastening regions 56. Such elements can be formed as clamps for instance and have anchoring regions that engage by locking in place when slid in corresponding contours, for example, with recesses of radial regions 56. Such elements can thereby at least be partially self-resilient or be anchored by plastic deformation, for example, by compression, so that they are secured against the centrifugal force acting on them.

### List of Reference Symbols:

1 drive train
2 -
3 drive unit
4 crankshaft
5 transmission
6 twin clutch
7 -
8 torsional vibration damping device
9 screw connection
10 screw connection
11 input part
12 ring gear
13 -
14 -
15 -
16 spring device
17 -
18 output part
19 friction ring
20 axial inserted-connection
21 -
22 clutch-cover part
23 -
24 -
25 -
26 intermediate pressure plate
27 -
28 pressure plate
29 friction linings
30 -
31 first clutch disc
32 -
33 hub part
34 -
35 first transmission input shaft
36 second transmission input shaft
37 roller bearing
38 hub part
39 pressure plate
40 friction linings
41 -
42 second clutch disc
43 hub part
44 clutch cover
45 -
46 actuation device
47 actuation device
48 actuation levers
49 actuation levers
50 pulling element
51 axial lobes
52 riveted connections
53 radial lobes
54 axial lobes
55 riveted connection
56 radially protruding regions
57 recess
58 balancing elements
59 screw elements
60 tool socket
61 fixing tool
62 threaded section
63 screw heads

1. A friction clutch comprising:
a clutch cover;
a pressure plate non-rotatably connected with the clutch cover, wherein the pressure plate is limitedly axially displaceable;
an actuation means operatively arranged between the clutch cover and the pressure plate arranged to exert axially directed force on the pressure plate; and,
at least a constituent component part having a plurality of recesses arranged to receive a plurality of screw elements, wherein the screw elements are arranged to balance the friction clutch when fixedly received within the plurality of recesses.

2. The friction clutch recited in claim 1, wherein the plurality of recesses are arranged in a plurality of groups distributed along the circumference of the friction clutch.

3. The friction clutch recited in claim 1, wherein each of the plurality of screw elements includes a threaded section that automatically taps the screw thread.

4. The friction clutch recited in claim 1, wherein the clutch cover includes a plurality of recesses arranged to receive the plurality of screw elements.

5. The friction clutch recited in claim 1, wherein the clutch cover includes a plurality of radially protruding regions on its outer circumference, having a plurality of recesses arranged to receive a plurality of screw elements arranged to be screwed in axially.

6. The friction clutch recited in claim 1, wherein the plurality of screw elements find application with different weights.

7. The friction clutch recited in claim 1, wherein each of the plurality of screw elements includes a threaded section and an adjoining screw head, forming a balancing weight, with a socket for a screw-driving tool.

8. The friction clutch recited in claim 1 arranged as a twin clutch with a clutch cover that can be coupled with a driving flywheel, and a connection cover that can be coupled with a pressure plate of the clutch, wherein a pressure plate respectively is assigned to a clutch which can be pressed by actuation means, which are effective between the clutch cover and said two pressure plates and at least one of the covers featuring recesses for receiving screw elements used as balancing weight.

8. The friction clutch recited in claim 1, wherein a second clutch cover is axially at least partially arranged within a connection cover and includes a plurality radially protruding regions along its circumference in which recesses distributed in circumferential direction are provided for receiving the screw elements.

9. The friction clutch recited in claim 1, wherein a connection cover forms a plurality of axially extending lobes on its outer circumference which form fastening regions for coupling with a pressure plate and radial regions of the clutch cover, with respect to the circumferential direction of the friction clutch, are provided respectively between two such lobes.

10. The friction clutch recited in claim 1, wherein the plurality of recesses are arranged in a plurality of radial regions of the clutch cover opposite the outer fictitious enveloping surface of the connection cover are disposed radially in such a manner that they are at least axially accessible even in a mounted state of the twin clutch.
